(19) United States
(12) Patent Application Publication
(10) Pub. No.: US 2025/0068827 A1
(43) Pub. Date: Feb. 27, 2025

(54) GENERATION AND MANAGEMENT OF FORMATTED CONTENT USING MACHINE LEARNING TECHNOLOGIES

(71) Applicant: Twilio Inc., San Francisco, CA (US)

(72) Inventors: Shannon Cawley, San Francisco, CA (US); Troy Bolus, San Francisco, CA (US); Alexandre Millet, San Francisco, CA (US)

(21) Appl. No.: 18/812,815

(22) Filed: Aug. 22, 2024

Related U.S. Application Data
(60) Provisional application No. 63/534,099, filed on Aug. 22, 2023.

(51) Int. Cl. G06F 40/103; G06F 40/186

(52) U.S. Cl. CPC G06F 40/103; G06F 40/186

(57) ABSTRACT

Various embodiments described herein support or provide operations for facilitating the generation and management of formatted content using machine learning technologies. Specifically, elements of an email are received. Prompts are generated as inputs to machine learning models based on the elements of the email. The machine learning models are used to generate formatted content based on the prompts. Emails are generated based on the formatted content and caused to be displayed on devices.

### CLAIM OF PRIORITY

This application claims the benefit of priority to U.S. Provisional Application Ser. No. 63/534,099, filed on Aug. 22, 2023, which is incorporated herein by reference in its entirety.

### TECHNICAL FIELD

Various embodiments described herein provide for systems, methods, techniques, instruction sequences, and devices that facilitate the generation and management of formatted content using machine learning technologies.

### BACKGROUND

Creating high-quality marketing emails takes a tremendous amount of time, effort, and cross-team coordination. Current systems face challenges when it comes to generating brand-specific, visually appealing, and consistent content that helps facilitate better-performing marketing communications, including reducing time spent on content creation and improving user engagement in marketing campaigns.

### BRIEF DESCRIPTION OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some embodiments are illustrated by way of examples, and not limitations, in the accompanying figures.

FIG. 1 is a block diagram showing an example data system that includes a data management system in an artificial intelligence system, according to various embodiments of the present disclosure.

FIG. 2 is a block diagram illustrating an example data management system that facilitates the generation and management of formatted content using machine learning technologies, according to various embodiments of the present disclosure.

FIG. 3 is a flowchart illustrating an example method for facilitating the generation and management of formatted content using machine learning technologies, according to various embodiments of the present disclosure.

FIG. 4 is a flowchart illustrating an example method for facilitating the generation and management of formatted content using machine learning technologies, according to various embodiments of the present disclosure.

FIG. 5 is a flowchart illustrating an example method for facilitating the generation and management of formatted content using machine learning technologies, according to various embodiments of the present disclosure.

FIG. 6 illustrates an example graphical user interface showing a plurality of input fields for receiving user inputs used for generating formatted content, according to various embodiments of the present disclosure.

FIG. 7 illustrates an example graphical user interface showing a portion of an example formatted content generated using machine learning technologies, according to various embodiments of the present disclosure.

FIG. 8 illustrates example graphical user interfaces showing example formatted content generated using machine learning technologies, according to various embodiments of the present disclosure.

FIG. 9 is a block diagram illustrating a representative software architecture, which may be used in conjunction with various hardware architectures herein described, according to various embodiments of the present disclosure.

FIG. 10 is a block diagram illustrating components of a machine able to read instructions from a machine storage medium and perform any one or more of the methodologies discussed herein according to various embodiments of the present disclosure.

### DETAILED DESCRIPTION

The description that follows includes systems, methods, techniques, instruction sequences, and computing machine program products that embody illustrative embodiments of the present disclosure. In the following description, for purposes of explanation, numerous specific details are set forth in order to provide a thorough understanding of embodiments. It will be evident, however, to one skilled in the art that the present inventive subject matter can be practiced without these specific details.

Reference in the specification to “one embodiment” or “an embodiment” means that a particular feature, structure, or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment.

For purposes of explanation, specific configurations, and details are set forth in order to provide a thorough understanding of the present subject matter. However, it will be apparent to one of ordinary skill in the art that embodiments of the subject matter described can be practiced without the specific details presented herein, or in various combinations, as described herein. Furthermore, well-known features can be omitted or simplified in order not to obscure the described embodiments. Various embodiments may be given throughout this description. These are merely descriptions of specific embodiments. The scope or meaning of the claims is not limited to the embodiments given.

Email marketing has become an essential tool for businesses to communicate with customers and promote products or services. However, creating effective email campaigns presents several challenges. Designing visually appealing emails that align with brand guidelines requires significant time and effort. Personalizing content for individual recipients adds another layer of complexity. Marketers must also ensure emails display correctly across various devices and email clients. Additionally, maintaining consistency in messaging and design across multiple campaigns can be difficult, especially for larger organizations. The process of crafting email content, designing layouts, and incorporating brand elements often involves collaboration between multiple team members, which can further extend production timelines. As email volume continues to increase, marketers face pressure to produce high-quality, engaging content more rapidly while still adhering to best practices and regulatory requirements.

Various embodiments include systems, methods, and non-transitory computer-readable media that facilitate the generation and management of formatted content using machine learning technologies, aiming to address the challenges of efficiently creating personalized, on-brand email campaigns. Example formatted content can include software code (e.g., HTML code) that can be used to generate an email message (also referred to as an email) that can be displayed in a user interface of a device. Various embodiments allow users to optimize email generation and campaign design processes to create personalized, well-performing, on-brand, and consistent content, while reducing the time needed to create it. Various embodiments also allow content personalization to improve user engagement. By allowing users to build collections of content templates, various embodiments automate the content design and drafting process, thereby reducing manual effort and freeing up users' (e.g., marketers) valuable time to focus on more important tasks, such as optimizing campaign strategy.

In various embodiments, a data management system receives user inputs that include one or more elements of content (e.g., email). For example, elements of an email can include, without limitation, headers, footers, text blocks, images, campaign type, campaign description, layout of emails, personalization elements, brand assets (e.g., brand logos, brand images), email templates, etc. In various embodiments, content, or content items, can include emails, instant messages, and any form of medium used for communication.

In various embodiments, the data management system generates, based on the one or more elements of the email, prompts as inputs to one or more machine learning models (e.g., large language models). A prompt can include instructions, questions, and/or any other type of input used to interact with machine learning models. A prompt can also include specific constraints or requirements, such as tone, style, format, and/or desired length of the response, to ensure the responses of the machine learning models meet the requirements of a custom use case.

In various embodiments, the data management system uses one or more machine learning models to generate formatted content based on the prompt. The one or more machine learning models can include at least one large language model. The generated content can be a brand-specific email described herein. The use of a machine learning model allows for the generation of content that is not only on-brand but also contextually relevant to the specific campaign or message being created.

In various embodiments, the data management system can generate the content based on the formatted content. This allows for human oversight and refinement of the machine-generated content, ensuring that the final product meets the specific needs of the campaign. An example of formatted content can include HTML code that can be used to generate the content (e.g., an HTML email).

In various embodiments, the generated email can be presented (caused to be displayed) on a user interface of the device. In various embodiments, an email can be displayed on a user interface of an administrative device associated with a user (e.g., marketer), and can subsequently be displayed on a user interface of a recipient device associated with an individual (e.g., a target user who receives brand-specific content).

In various embodiments, the data management system can cause display of a user interface on a device. The user interface can include one or more input fields to receive one or more elements of the content described herein. Users can input specific elements through these fields, allowing for granular customization of the email content. This approach provides flexibility for users who may want to exercise more control over certain aspects of the email while still benefiting from the efficiency of the machine learning-generated content.

In various embodiments, the data management system can generate one or more templates based on the formatted content generated by the one or more machine learning models. Templates can be stored alongside existing email templates associated with the same brand, providing users with a selection of options for future use. This allows for the building of a robust template library over time, which can significantly reduce the time required for future email creation.

In various embodiments, the data management system can access historical data associated with a brand. The machine learning model can infer and generate brand-specific elements based on historical data. This allows for a level of brand consistency that might be difficult to achieve manually, especially for organizations with complex brand guidelines or large marketing teams. Historical data can include a plurality of content items (e.g., emails) associated with the brand.

In various embodiments, the data management system uses one or more machine learning models (e.g., large language model) to generate, based on the historical data associated with the brand, a plurality of elements associated with the brand based on inference. Inference in machine learning refers to a model's capability to generate predictions or responses based on provided context and inputs, such as prompts. Upon receiving a prompt, the model leverages its trained understanding of language and context to produce a response that is both relevant and appropriate. This process allows the model to interpret the input and deliver accurate, contextually aware outputs.

In various embodiments, a machine learning model's outputs (e.g., formatted content) can be in HTML format and saved as an email template. An email template can be further edited via tools, such as the code editor and the Visual HTML Editor.

In various embodiments, the data management system receives user requests to modify an email (or an email template) generated by the one or more machine learning models. The data management system can store the modified email as an email template for user selection, further expanding the library of available designs. This iterative process allows for continuous improvement and refinement of the email templates over time, based on real-world usage and feedback.

In various embodiments, the data management system can generate multiple versions of formatted content (e.g., emails) based on a single prompt. This results in the creation of several email options, which are then presented to the user for selection. This can be particularly useful for A/B testing or for campaigns where multiple approaches are being considered.

Various embodiments also support partial email generation. One or more portions of formatted content (e.g., an email) can be generated and updated using the machine learning models described herein. Users can specify a particular portion of the email they want to update, and the system can use the machine learning model to generate content specifically for that section. This feature allows for targeted refinement of emails, which can be useful for updating specific sections of recurring emails or for making quick adjustments to templates.

Various embodiments aim to streamline the content creation process, particularly for marketing professionals. The technology addresses several pain points in email marketing, including the time-consuming nature of email design, the challenge of maintaining brand consistency, and the need for personalization. By leveraging machine learning models, the data management system can generate on-brand, personalized email templates in minutes, significantly reducing the time typically required for this task. This efficiency gain allows marketers to focus more on campaign strategy and optimization rather than spending hours on email design and cross-functional collaboration.

Various embodiments also aim to improve the onboarding process for new customers of email marketing platforms. Providing a way to quickly build a template library can reduce the time required to publish initial campaigns following onboarding. This can be particularly beneficial for small businesses or organizations new to email marketing, allowing them to quickly establish a professional email presence.

Reference will now be made in detail to embodiments of the present disclosure, examples of which are illustrated in the appended drawings. The present disclosure may, however, be embodied in many different forms and should not be construed as being limited to the embodiments set forth herein.

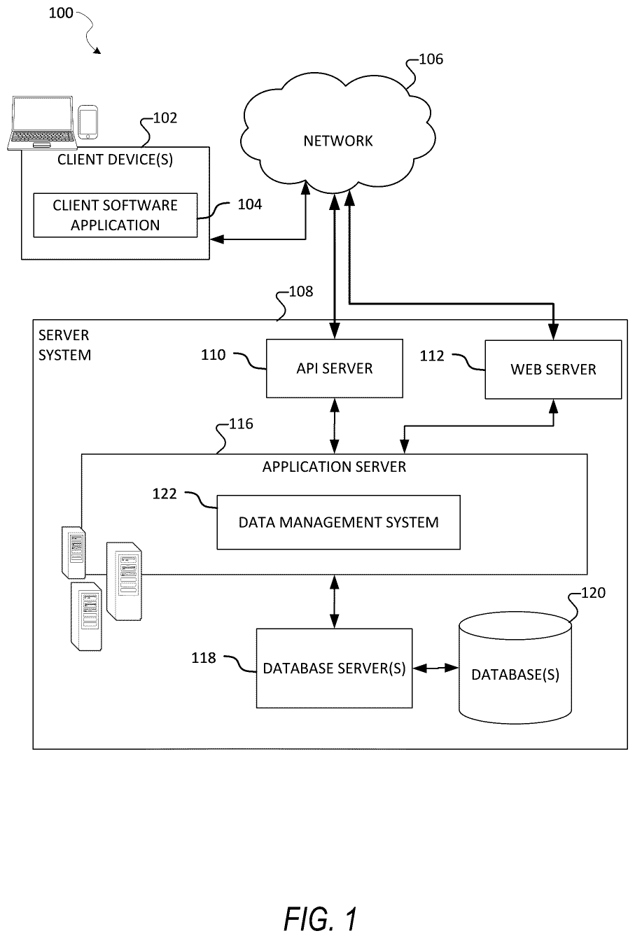

FIG. 1 is a block diagram showing an example data system 100 that includes a data management system (hereafter, the data management system 122, or system 122), according to various embodiments of the present disclosure. By including the data management system 122, the data system 100 can facilitate the generation and management of formatted content using machine learning technologies. As shown, the data system 100 includes one or more client devices 102, a server system 108, and a network 106 (e.g., including Internet, wide-area-network (WAN), local-area-network (LAN), wireless network, etc.) that communicatively couples them together. Each client device 102 can host a number of applications, including a client software application 104. The client software application 104 can communicate data with the server system 108 via a network 106. Accordingly, the client software application 104 can communicate and exchange data with the server system 108 via network 106.

The server system 108 provides server-side functionality via the network 106 to the client software application 104. While certain functions of the data system 100 are described herein as being performed by the data management system 122 on the server system 108.

It will be appreciated that the location of certain functionality within the server system 108 is a design choice. For example, it may be technically preferable to initially deploy certain technology and functionality within the server system 108, but to later migrate this technology and functionality to the client software application 104.

The server system 108 supports various services and operations that are provided to the client software application 104 by the data management system 122. Such operations include transmitting data from the data management system 122 to the client software application 104, receiving data from the client software application 104 to the system 122, and the system 122 processing data generated by the client software application 104. Data exchanges within the data system 100 may be invoked and controlled through operations of software component environments available via one or more endpoints, or functions available via one or more user interfaces of the client software application 104, which may include web-based user interfaces provided by the server system 108 for presentation at the client device 102.

With respect to the server system 108, each of an Application Program Interface (API) server 110 and a web server 112 is coupled to an application server 116, which hosts the data management system 122. The application server 116 is communicatively coupled to a database server 118, which facilitates access to a database 120 that stores data associated with the application server 116, including data that may be generated or used by the data management system 122.

The API server 110 receives and transmits data (e.g., API calls, commands, requests, responses, and authentication data) between the client device 102 and the application server 116. Specifically, the API server 110 provides a set of interfaces (e.g., routines and protocols) that can be called or queried by the client software application 104 in order to invoke the functionality of the application server 116. The API server 110 exposes various functions supported by the application server 116 including, without limitation: user registration; login functionality; data object operations (e.g., generating, storing, retrieving, encrypting, decrypting, transferring, access rights, licensing, etc.); and user communications.

Through one or more web-based interfaces (e.g., web-based user interfaces), the web server 112 can support various functionality of the data management system 122 of the application server 116.

The application server 116 hosts a number of applications and subsystems, including the data management system 122, which supports various functions and services with respect to various embodiments described herein. The application server 116 is communicatively coupled to a database server 118, which facilitates access to database(s) 120 that stores data associated with the data management system 122.

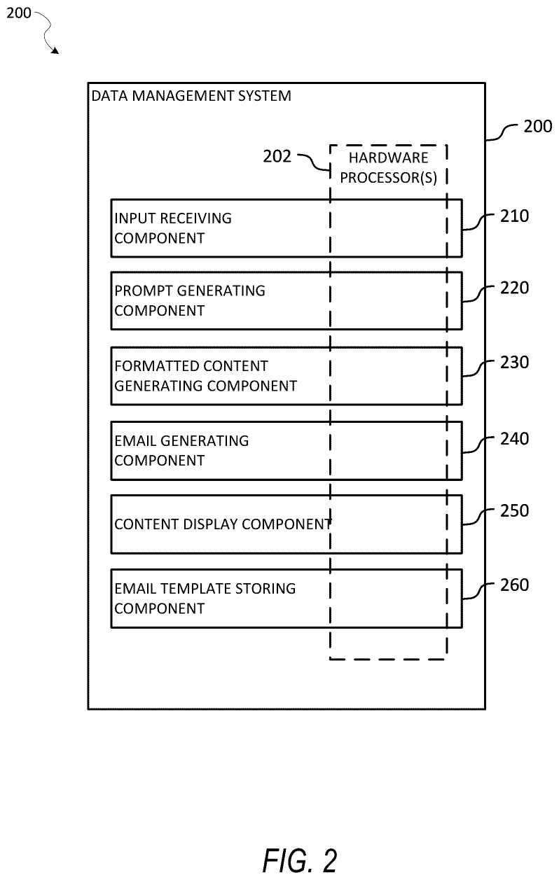

FIG. 2 is a block diagram illustrating an example data management system 200 that facilitates the generation and management of formatted content using machine learning technologies, according to various embodiments of the present disclosure. For some embodiments, the data management system 200 represents an example of the data management system 122 described with respect to FIG. 1. As shown, the data management system 200 comprises an input receiving component 210, a prompt generating component 220, a formatted content generating component 230, an email generating component 240, a content display component 250, an email template storing component 260. According to various embodiments, one or more of the input receiving component 210, the prompt generating component 220, the formatted content generating component 230, the email generating component 240, the content display component 250, the email template storing component 260 are implemented by one or more hardware processors 202. Data generated by one or more of the input receiving component 210, the prompt generating component 220, the formatted content generating component 230, the email generating component 240, the content display component 250, the email template storing component 260 can be stored in a database (not shown) of the data management system 200.

The input receiving component 210 is configured to receive user inputs that include one or more elements of a content item (e.g., an email) described herein. For example, elements of an email can include, without limitation, headers, footers, text blocks, images, campaign type, campaign description, layout of emails, personalization elements, brand assets (e.g., brand logos, brand images), email templates, etc. Content, or content items, can include emails, instant messages, and any form of medium used for communication.

The prompt generating component 220 is configured to generate, based on the one or more elements of the content item (e.g., an email), prompts as inputs to one or more machine learning models (e.g., large language models). A prompt can include instructions, questions, and/or any other type of input used to interact with machine learning models. A prompt can also include specific constraints or requirements, such as tone, style, format, and/or desired length of the response, to ensure the responses of the machine learning models meet the requirements of a custom use case.

The formatted content generating component 230 is configured to generate formatted content based on the prompt. The one or more machine learning models can include at least one large language model. The generated content can be one or more brand-specific emails described herein.

The email generating component 240 is configured to generate emails based on the formatted content generated by large language models. An example of formatted content can include HTML code that can be used to generate an HTML email that can be displayed in a user interface of a device.

The content display component 250 is configured to cause the display of generated content items (e.g., emails) on a user interface of a device. An email can be displayed on a user interface of an administrative device associated with a user (e.g., marketer), and can subsequently be displayed on a user interface of a recipient device associated with an individual (e.g., a target user who receives brand-specific content). This approach helps ensure that the email will display correctly for recipients, regardless of the devices they are using.

The template storing component 260 is configured to generate one or more email templates based on the formatted content generated by one or more machine learning models store the one or more email templates along with a plurality of existing email templates associated with a specific brand, providing users with a selection of options for future use.

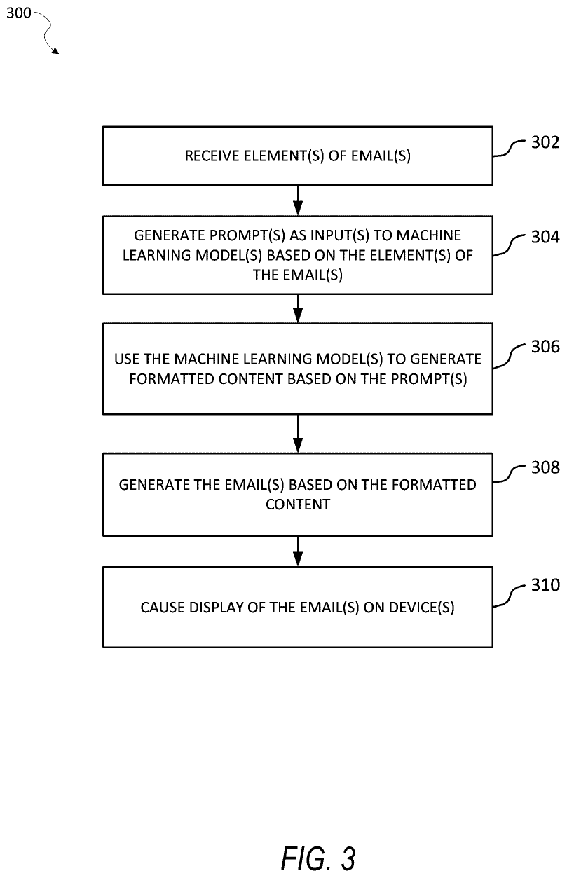

FIG. 3 is a flowchart illustrating an example method 300 for facilitating the generation and management of formatted content using machine learning technologies, according to various embodiments of the present disclosure. It will be understood that example methods described herein may be performed by a machine in accordance with some embodiments. For example, method 300 can be performed by the data management system 122 described with respect to FIG. 1, the data management system 200 described with respect to FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 300 may be represented by executable instructions that, when executed by a processor of a computing device, cause the computing device to perform method 300. Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel.

At operation 302, a processor receives user inputs, via one or more user interfaces, that include one or more elements of an email. Example elements of an email can include, without limitation, headers, footers, text blocks, images, campaign type, campaign description, layout of emails, personalization elements, brand assets (e.g., brand logos, brand images), email templates, etc. Brand assets can be accessed via one or more Uniform Resource Locators (URLs) or Uniform Resource Identifiers (URIs) provided by a user.

At operation 304, a processor generates, based on the one or more elements of the email, prompts as inputs to one or more machine learning models (e.g., large language models). A prompt can include instructions, questions, and/or any other type of input used to interact with machine learning models. A prompt can also include specific constraints or requirements, such as tone, style, format, and/or desired length of the response, to ensure the responses of the machine learning models meet the requirements of a custom use case.

At operation 306, a processor uses one or more machine learning models (e.g., large language models) to generate formatted content based on the prompts. Example formatted content can include HTML code that can be used to generate an HTML email that can be displayed in a user interface of a device. The use of a machine learning model allows for the generation of content that is not only on-brand but also contextually relevant to the specific campaign or message being created.

At operation 308, a processor generates emails based on the formatted content. In various embodiments, one or more portions of an email can be generated and updated using the machine learning models described herein. This allows for human oversight and refinement of the machine-generated content, ensuring that the final product meets the specific needs of the campaign.

At operation 310, a processor causes the display of one or more emails in a user interface of a device. An email can be displayed on a user interface of an administrative device associated with a user (e.g., marketer), and can subsequently be displayed on a user interface of a recipient device associated with an individual (e.g., a target user who receives brand-specific content).

Though not illustrated, method 300 can include an operation where a graphical user interface can be displayed (or caused to be displayed) by the hardware processor. For instance, the operation can cause a client device (e.g., the client device 102 communicatively coupled to the data management system 122) to display the graphical user interface. This operation for displaying the graphical user interface can be separate from operations 302 through 310 or, alternatively, form part of one or more of operations 302 through 310.

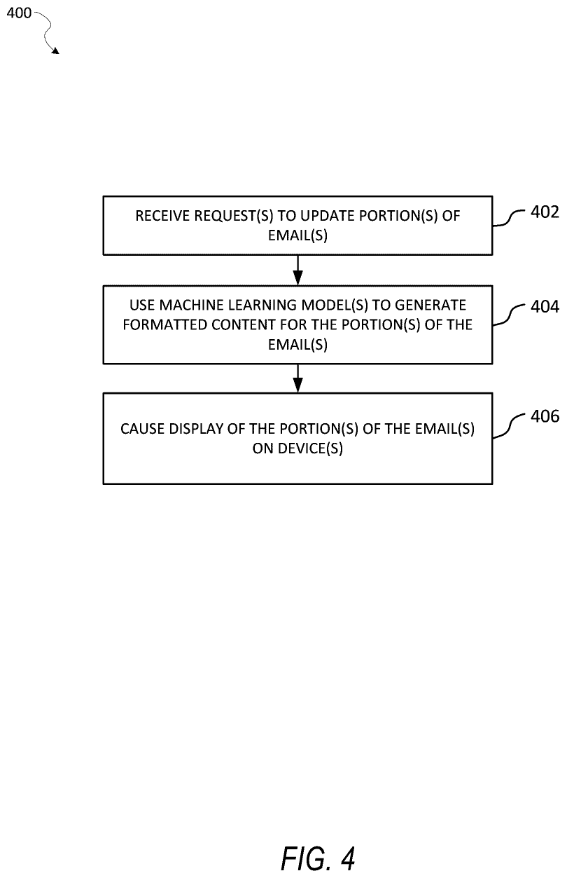

FIG. 4 is a flowchart illustrating an example method 400 for facilitating the generation and management of formatted content using machine learning technologies, according to various embodiments of the present disclosure. It will be understood that example methods described herein may be performed by a machine in accordance with some embodiments. For example, method 400 can be performed by the data management system 122 described with respect to FIG. 1, the data management system 200 described with respect to FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 400 may be represented by executable instructions that, when executed by a processor of a computing device, cause the computing device to perform method 400. Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel. Operations in method 400 can be performed dependently or independently from operations in method 300.

At operation 402, a processor receives one or more requests to update one or more portions of an email.

At operation 404, a processor uses one or more machine learning models (e.g., large language models) to generate formatted content for the specified portions of the email. The processor can instruct a large language model to update portions of an email through various methods. For example, the processor can first capture user's inputs, indicating which portion of the email needs to be updated. This could be a highlighted section, a specific tag (e.g., “Introduction”), or a command (e.g., “Update the subject line”). The processor can analyze the email content to locate and isolate the specified section. Natural language processing (NLP) techniques may be used to understand the structure of the email, such as identifying paragraphs, headings, or specific phrases, etc. The processor extracts relevant context from the email, including surrounding text, tone, and any other user instructions, and formats the target section and context into a structured input that the ML model can process. This can include text prompts that describe the task, such as “Generate a more formal introduction” or “Rewrite this paragraph for clarity.” The processor passes the formatted inputs to the ML model, which processes the prompt and generates updated content specifically for the identified section. The model draws on its training data and contextual understanding to produce a response aligned with the user's instructions.

At operation 406, a processor causes a display of the portions of the email on a device. Specifically, before presenting the portions of the email for display, the processor replaces the original section with the newly generated content, maintaining the overall structure and flow of the email. The processor may also present the updated portions to a user for review and approval before finalizing the email.

Though not illustrated, method 400 can include an operation where a graphical user interface can be displayed (or caused to be displayed) by the hardware processor. For instance, the operation can cause a client device (e.g., the client device 102 communicatively coupled to the data management system 122) to display the graphical user interface. This operation for displaying the graphical user interface can be separate from operations 402 through 406 or, alternatively, form part of one or more of operations 402 through 406.

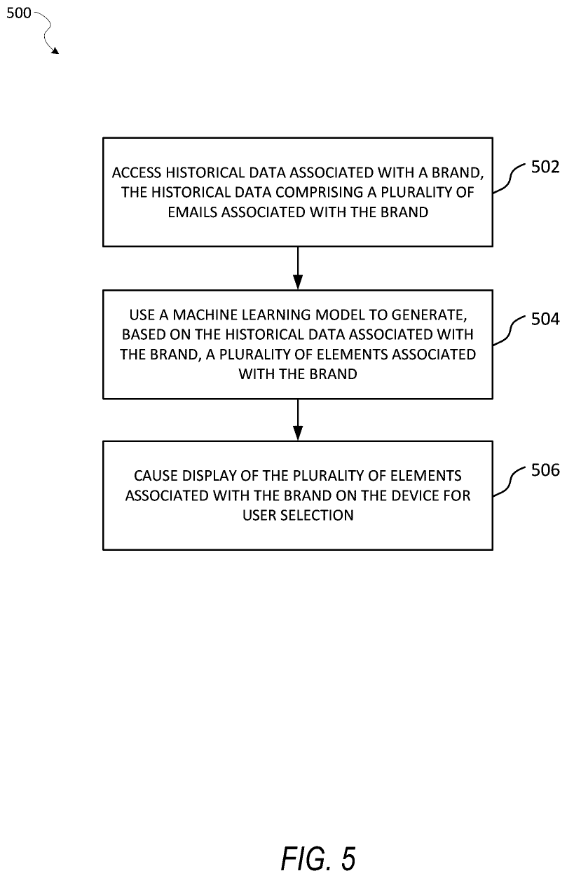

FIG. 5 is a flowchart illustrating an example method 500 for facilitating the generation and management of formatted content using machine learning technologies, according to various embodiments of the present disclosure. It will be understood that example methods described herein may be performed by a machine in accordance with some embodiments. For example, method 500 can be performed by the data management system 122 described with respect to FIG. 1, the data management system 200 described with respect to FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 500 may be represented by executable instructions that, when executed by a processor of a computing device, cause the computing device to perform method 500. Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel. Operations in method 500 can be performed dependently or independently from operations in method 300 and/or method 400.

At operation 502, a processor accesses historical data associated with a brand. The historical data can include a plurality of emails associated with the brand. Specifically, Historical data of a brand can include a range of email communications, such as promotional emails, customer service interactions, and transactional messages.

At operation 504, a processor uses one or more machine learning models (e.g., large language models) to generate a plurality of elements (e.g., headers, footers, text blocks, images, campaign type, campaign description, layout of emails) associated with the brand based on the historical data associated with the brand. Specifically, large language models can leverage patterns and information from past email communications, allowing for granular customization of the email content in future emails. For example, large language models can analyze these historical emails to understand common structures, language styles, and promotional strategies. For a new campaign, the models can generate elements of personalized marketing emails by incorporating similar language and style, tailored to the customer's previous interactions or purchase history.

At operation 506, a processor causes a display of the plurality of elements associated with the brand on the device for user selection.

Though not illustrated, method 500 can include an operation where a graphical user interface can be displayed (or caused to be displayed) by the hardware processor. For instance, the operation can cause a client device (e.g., the client device 102 communicatively coupled to the data management system 122) to display the graphical user interface. This operation for displaying the graphical user interface can be separate from operations 502 through 506 or, alternatively, form part of one or more of operations 502 through 506.

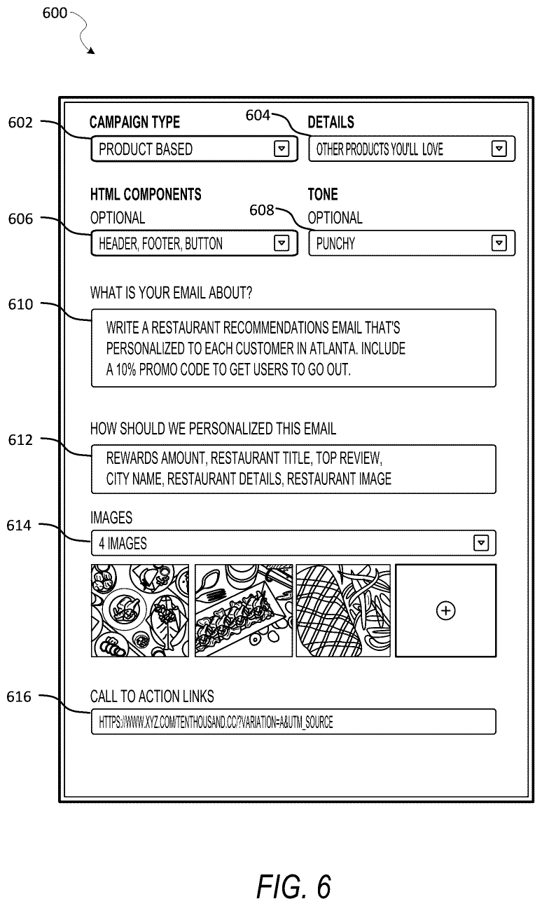

FIG. 6 illustrates an example graphical user interface 600 showing a plurality of input fields for receiving user inputs used for generating formatted content, according to various embodiments of the present disclosure. As shown, a user can enter elements of an email via the plurality of input fields 602-616. An input field (e.g., input fields 602-608) can provide (or be associated with) a list of available options via a drop-down menu (not shown) for user selection.

Campaign Selection: Users can start by selecting Campaign Type & Campaign Details, via input fields 602 and 604, from the available options, such as promotional, transactional, or product-based event invite, etc.

Specify layout or HTML components: Users can specify the preferred email layout or specific HTML components, via input field 606, to be included in emails. This can involve selecting from predefined layout options or specifying customer HTML elements, such as headers, footers, columns, etc.

Specify a model template: Users can select an email template or import (e.g., paste) an email (or a portion of an email) in HTML format they would like to model off. The token limitations of machine learning models can prevent the system from creating new templates from scratch each time. Requiring the user to select from an existing template can reduce the time spent on generating emails described herein.

Users can briefly describe an email campaign and any messaging they would like to include in an email. This enables the machine learning model to generate an email template that aligns with the email campaign goals and objectives.

Users have the option to indicate the desired tone of the email via input field 608. Example tones can include formal, casual, playful, and professional.

Add personalization: Users can describe the personalization elements (merge tags or liquid syntax) they would like to include elements via input field 612. Example personalization elements can include customer name, location, purchase history, etc.

Include brand assets: Users can have the option to add brand assets (via input field 614) to the email so that the generated email is aligned with brand guidelines. Example brand assets can include brand images, logos, and URLs (via input field 616) associated with the assets. Additional context for the brand assets can be included, such as text fonts that pair with the brand assets, etc.

Generate email: Upon submitting elements, users are alerted that the email generation is in progress. The system passes the inputs to the machine learning model to generate formatted content described herein.

Review, modify, and finalize the email: Users can be notified when the emails have been successfully generated. An email template can be generated based on the formatted content. Users can modify the email to be more tailored to the campaign's needs. Once complete, users can complete the final review and elect to save the email or return to the user interface 600 to generate a new email and/or email template.

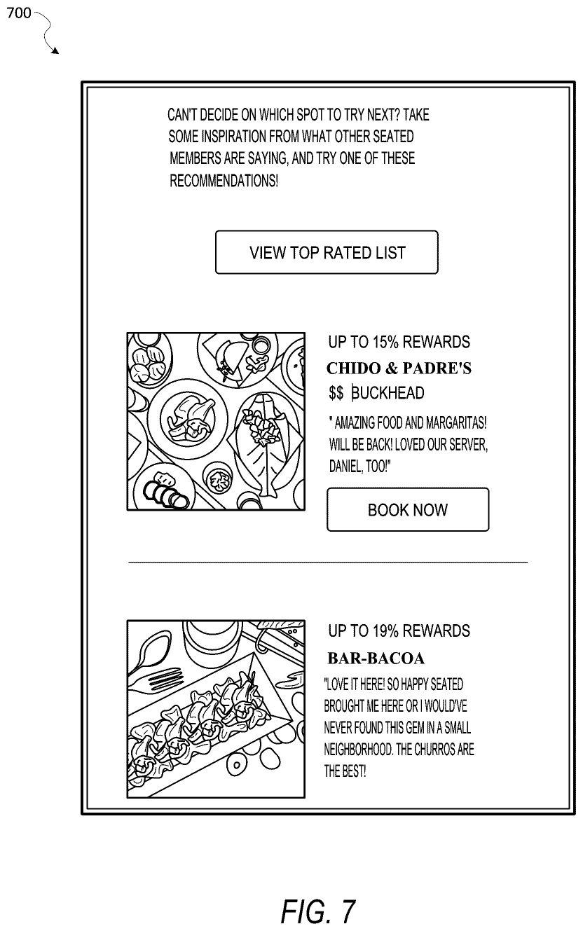

FIG. 7 illustrates an example graphical user interface 700 showing a portion of an example formatted content generated using machine learning technologies, according to various embodiments of the present disclosure. The example graphical user interface 700 includes a portion of an email generated based on the elements described in FIG. 6 using machine learning technologies described herein.

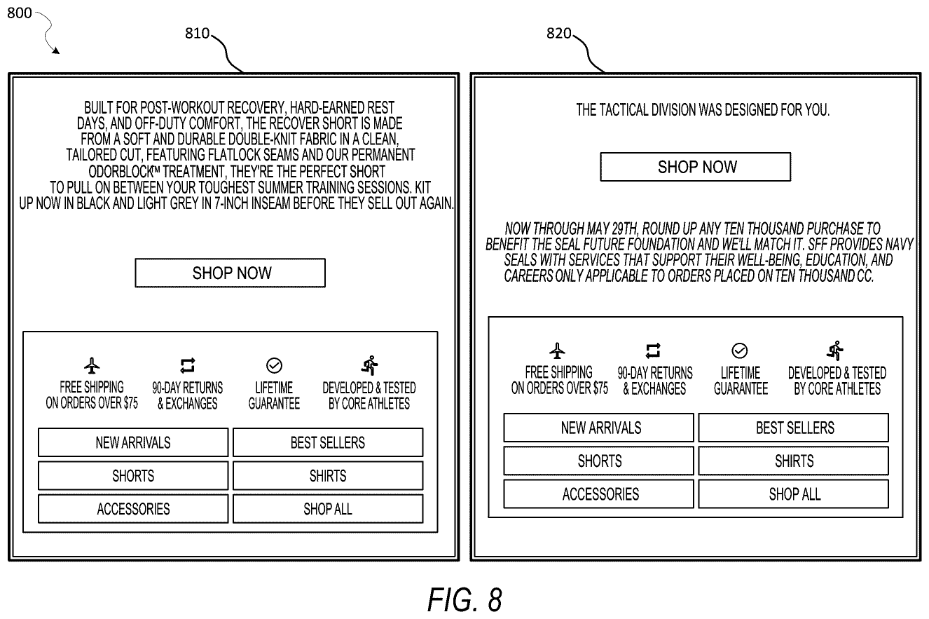

FIG. 8 illustrates example graphical user interfaces 810 and 820, showing example formatted content generated using machine learning technologies, according to various embodiments of the present disclosure. The example graphical user interfaces 810 and 820 illustrate portions of two different emails generated for a user based on shared elements described herein.

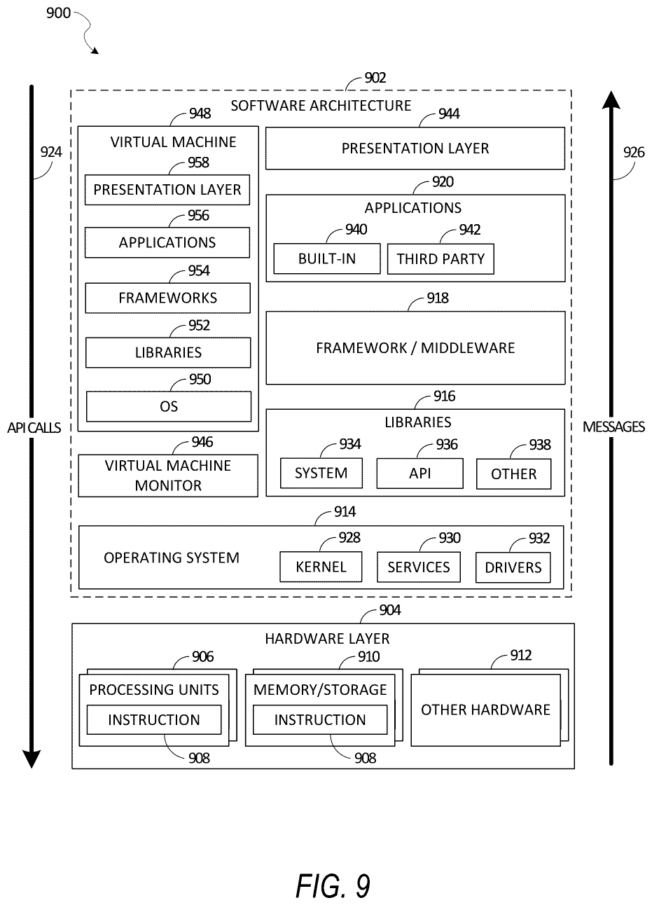

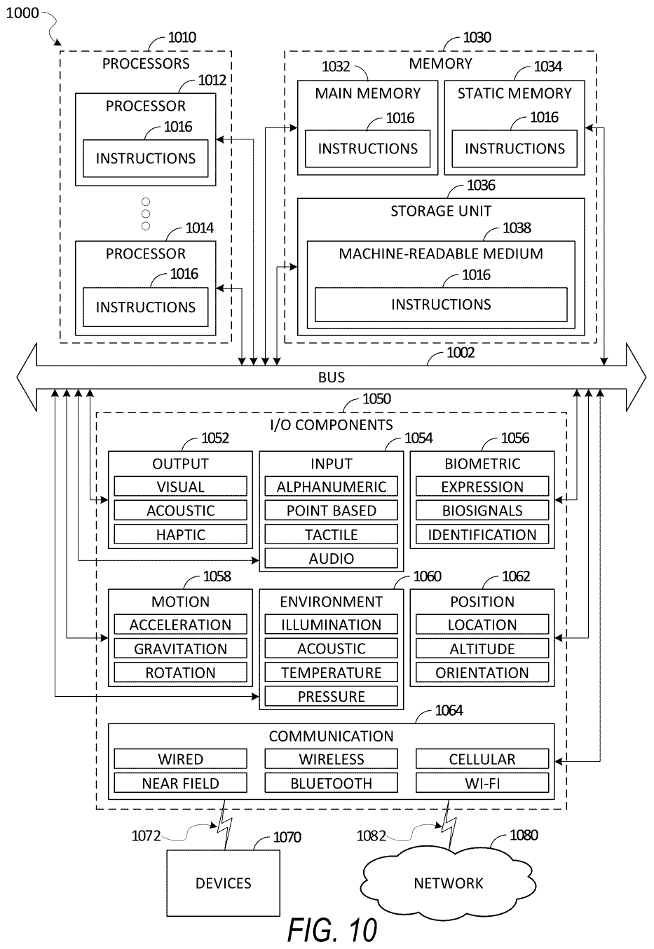

FIG. 9 is a block diagram 900 illustrating an example of a software architecture 902 that may be installed on a machine, according to some example embodiments. FIG. 9 is merely a non-limiting example of a software architecture, and it will be appreciated that many other architectures may be implemented to facilitate the functionality described herein. The software architecture 902 may be executing on hardware such as a machine 1000 of FIG. 10 that includes, among other things, processors 1010, memory 1030, and input/output (I/O) components 1050. A representative hardware layer 904 is illustrated and can represent, for example, the machine 1000 of FIG. 10. The representative hardware layer 904 comprises one or more processing units 906 having associated executable instructions 908. The executable instructions 908 represent the executable instructions of the software architecture 902. The hardware layer 904 also includes memory or storage modules 910, which also have the executable instructions 908. The hardware layer 904 may also comprise other hardware 912, which represents any other hardware of the hardware layer 904, such as the other hardware illustrated as part of the machine 1000.

In the example architecture of FIG. 9, the software architecture 902 may be conceptualized as a stack of layers, where each layer provides particular functionality. For example, the software architecture 902 may include layers such as an operating system 914, libraries 916, frameworks/middleware 918, applications 920, and a presentation layer 944. Operationally, the applications 920 or other components within the layers may invoke API calls 924 through the software stack and receive a response, returned values, and so forth (illustrated as messages 926) in response to the API calls 924. The layers illustrated are representative in nature, and not all software architectures have all layers. For example, some mobile or special-purpose operating systems may not provide a frameworks/middleware 918 layer, while others may provide such a layer. Other software architectures may include additional or different layers.

The operating system 914 may manage hardware resources and provide common services. The operating system 914 may include, for example, a kernel 928, services 930, and drivers 932. The kernel 928 may act as an abstraction layer between the hardware and the other software layers. For example, the kernel 928 may be responsible for memory management, processor management (e.g., scheduling), component management, networking, security settings, and so on. The services 930 may provide other common services for the other software layers. The drivers 932 may be responsible for controlling or interfacing with the underlying hardware. For instance, the drivers 932 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 916 may provide a common infrastructure that may be utilized by the applications 920 and/or other components and/or layers. The libraries 916 typically provide functionality that allows other software modules to perform tasks in an easier fashion than by interfacing directly with the underlying operating system 914 functionality (e.g., kernel 928, services 930, or drivers 932). The libraries 916 may include system libraries 934 (e.g., C standard library) that may provide functions such as memory allocation functions, string manipulation functions, mathematic functions, and the like. In addition, the libraries 916 may include API libraries 936 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 916 may also include a wide variety of other libraries 938 to provide many other APIs to the applications 920 and other software components/modules.

The frameworks 918 (also sometimes referred to as middleware) may provide a higher-level common infrastructure that may be utilized by the applications 920 or other software components/modules. For example, the frameworks 918 may provide various graphical user interface functions, high-level resource management, high-level location services, and so forth. The frameworks 918 may provide a broad spectrum of other APIs that may be utilized by the applications 920 and/or other software components/modules, some of which may be specific to a particular operating system or platform.

The applications 920 include built-in applications 940 and/or third-party applications 942. Examples of representative built-in applications 940 may include, but are not limited to, a home application, a contacts application, a browser application, a book reader application, a location application, a media application, a messaging application, or a game application.

The third-party applications 942 may include any of the built-in applications 940, as well as a broad assortment of other applications. In a specific example, the third-party applications 942 (e.g., an application developed using the Android™ or iOS™ software development kit (SDK) by an entity other than the vendor of the particular platform) may be mobile software running on a mobile operating system such as iOS™, Android™, or other mobile operating systems. In this example, the third-party applications 942 may invoke the API calls 924 provided by the mobile operating system such as the operating system 914 to facilitate functionality described herein.

The applications 920 may utilize built-in operating system functions (e.g., kernel 928, services 930, or drivers 932), libraries (e.g., system libraries 934, API libraries 936, and other libraries 938), or frameworks/middleware 918 to create user interfaces to interact with users of the system. Alternatively, or additionally, in some systems, interactions with a user may occur through a presentation layer, such as the presentation layer 944. In these systems, the application/module “logic” can be separated from the aspects of the application/module that interact with the user.

Some software architectures utilize virtual machines. In the example of FIG. 9, this is illustrated by a virtual machine 948. The virtual machine 948 creates a software environment where applications/modules can execute as if they were executing on a hardware machine (e.g., the machine 1000 of FIG. 10). The virtual machine 948 is hosted by a host operating system (e.g., the operating system 914) and typically, although not always, has a virtual machine monitor 946, which manages the operation of the virtual machine 948 as well as the interface with the host operating system (e.g., the operating system 914). A software architecture executes within the virtual machine 948, such as an operating system 950, libraries 952, frameworks/middleware 954, applications 956, or a presentation layer 958. These layers of software architecture executing within the virtual machine 948 can be the same as corresponding layers previously described or may be different.

FIG. 10 illustrates a diagrammatic representation of a machine 1000 in the form of a computer system within which a set of instructions may be executed for causing the machine 1000 to perform any one or more of the methodologies discussed herein, according to an embodiment. Specifically, FIG. 10 shows a diagrammatic representation of the machine 1000 in the example form of a computer system, within which instructions 1016 (e.g., software, a program, an application, an applet, an app, or other executable code) for causing the machine 1000 to perform any one or more of the methodologies discussed herein may be executed. For example, the instructions 1016 may cause the machine 1000 to execute the method 300 described above with respect to FIG. 3, the method 400 described above with respect to FIG. 4, and the method 500 described above with respect to FIG. 5. The instructions 1016 transform the general, non-programmed machine 1000 into a particular machine 1000 programmed to carry out the described and illustrated functions in the manner described. In alternative embodiments, the machine 1000 operates as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, or any machine capable of executing the instructions 1016, sequentially or otherwise, that specify actions to be taken by the machine 1000. Further, while only a single machine 1000 is illustrated, the term “machine” shall also be taken to include a collection of machines 1000 that individually or jointly execute the instructions 1016 to perform any one or more of the methodologies discussed herein.

The machine 1000 may include processors 1010, memory 1030, and I/O components 1050, which may be configured to communicate with each other such as via a bus 1002. In an embodiment, the processors 1010 (e.g., a hardware processor, such as a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 1012 and a processor 1014 that may execute the instructions 1016. The term “processor” is intended to include multi-core processors that may comprise two or more independent processors (sometimes referred to as “cores”) that may execute instructions contemporaneously. Although FIG. 10 shows multiple processors 1010, the machine 1000 may include a single processor with a single core, a single processor with multiple cores (e.g., a multi-core processor), multiple processors with a single core, multiple processors with multiples cores, or any combination thereof.

The memory 1030 may include a main memory 1032, a static memory 1034, and a storage unit 1036 including machine-readable medium 1038, each accessible to the processors 1010 such as via the bus 1002. The main memory 1032, the static memory 1034, and the storage unit 1036 store the instructions 1016 embodying any one or more of the methodologies or functions described herein. The instructions 1016 may also reside, completely or partially, within the main memory 1032, within the static memory 1034, within the storage unit 1036, within at least one of the processors 1010 (e.g., within the processor's cache memory), or any suitable combination thereof, during execution thereof by the machine 1000.

The I/O components 1050 may include a wide variety of components to receive input, provide output, produce output, transmit information, exchange information, capture measurements, and so on. The specific I/O components 1050 that are included in a particular machine will depend on the type of machine. For example, portable machines such as mobile phones will likely include a touch input device or other such input mechanisms, while a headless server machine will likely not include such a touch input device. It will be appreciated that the I/O components 1050 may include many other components that are not shown in FIG. 10. The I/O components 1050 are grouped according to functionality merely for simplifying the following discussion, and the grouping is in no way limiting. In various embodiments, the I/O components 1050 may include output components 1052 and input components 1054. The output components 1052 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1054 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further embodiments, the I/O components 1050 may include biometric components 1056, motion components 1058, environmental components 1060, or position components 1062, among a wide array of other components. The motion components 1058 may include acceleration sensor components (e.g., accelerometer), gravitation sensor components, rotation sensor components (e.g., gyroscope), and so forth. The environmental components 1060 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1062 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1050 may include communication components 1064 operable to couple the machine 1000 to a network 1080 or devices 1070 via a coupling 1082 and a coupling 1072, respectively. For example, the communication components 1064 may include a network interface component or another suitable device to interface with the network 1080. In further examples, the communication components 1064 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 1070 may be another machine or any of a wide variety of peripheral devices (e.g., a peripheral device coupled via a USB).

Moreover, the communication components 1064 may detect identifiers or include components operable to detect identifiers. For example, the communication components 1064 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1064, such as location via Internet Protocol (IP) geolocation, location via Wi-Fi® signal triangulation, location via detecting an NFC beacon signal that may indicate a particular location, and so forth.

Certain embodiments are described herein as including logic or a number of components, modules, elements, or mechanisms. Such modules can constitute either software modules (e.g., code embodied on a machine-readable medium or in a transmission signal) or hardware modules. A “hardware module” is a tangible unit capable of performing certain operations and can be configured or arranged in a certain physical manner. In various example embodiments, one or more computer systems (e.g., a standalone computer system, a client computer system, or a server computer system) or one or more hardware modules of a computer system (e.g., a processor or a group of processors) are configured by software (e.g., an application or application portion) as a hardware module that operates to perform certain operations as described herein.

In various embodiments, a hardware module is implemented mechanically, electronically, or any suitable combination thereof. For example, a hardware module can include dedicated circuitry or logic that is permanently configured to perform certain operations. For example, a hardware module can be a special-purpose processor, such as a field-programmable gate array (FPGA) or an ASIC. A hardware module may also include programmable logic or circuitry that is temporarily configured by software to perform certain operations. For example, a hardware module can include software encompassed within a general-purpose processor or other programmable processor. It will be appreciated that the decision to implement a hardware module mechanically, in dedicated and permanently configured circuitry, or in temporarily configured circuitry (e.g., configured by software) can be driven by cost and time considerations.

Accordingly, the phrase “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software can accordingly configure a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In embodiments in which multiple hardware modules are configured or instantiated at different times, communications between or among such hardware modules may be achieved, for example, through the storage and retrieval of information in memory structures to which the multiple hardware modules have access. For example, one hardware module performs an operation and stores the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines 1000 including processors 1010), with these operations being accessible via a network (e.g., the Internet) and via one or more appropriate interfaces (e.g., an API). In certain embodiments, for example, a client device may relay or operate in communication with cloud computing systems and may access circuit design information in a cloud environment.

The performance of certain of the operations may be distributed among the processors, not only residing within a single machine 1000, but deployed across a number of machines 1000. In some example embodiments, the processors 1010 or processor-implemented modules are located in a single geographic location (e.g., within a home environment, an office environment, or a server farm). In other example embodiments, the processors or processor-implemented modules are distributed across a number of geographic locations.

### Executable Instructions and Machine Storage Medium

The various memories (i.e., 1030, 1032, 1034, and/or the memory of the processor(s) 1010) and/or the storage unit 1036 may store one or more sets of instructions 1016 and data structures (e.g., software) embodying or utilized by any one or more of the methodologies or functions described herein. These instructions (e.g., the instructions 1016), when executed by the processor(s) 1010, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 1016 and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various embodiments, one or more portions of the network 1080 may be an ad hoc network, an intranet, an extranet, a virtual private network (VPN), a LAN, a wireless LAN (WLAN), a WAN, a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 1080 or a portion of the network 1080 may include a wireless or cellular network, and the coupling 1082 may be a Code Division Multiple Access (CDMA) connection, a Global System for Mobile communications (GSM) connection, or another type of cellular or wireless coupling. In this example, the coupling 1082 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions may be transmitted or received over the network using a transmission medium via a network interface device (e.g., a network interface component included in the communication components) and utilizing any one of a number of well-known transfer protocols (e.g., hypertext transfer protocol (HTTP)). Similarly, the instructions may be transmitted or received using a transmission medium via the coupling (e.g., a peer-to-peer coupling) to the devices 1070. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions for execution by the machine, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

### Computer-Readable Medium

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals. For instance, an embodiment described herein can be implemented using a non-transitory medium (e.g., a non-transitory computer-readable medium).

Throughout this specification, plural instances may implement resources, components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components.

As used herein, the term “or” may be construed in either an inclusive or exclusive sense. The terms “a” or “an” should be read as meaning “at least one,” “one or more,” or the like. The presence of broadening words and phrases such as “one or more,” “at least,” “but not limited to,” or other like phrases in some instances shall not be read to mean that the narrower case is intended or required in instances where such broadening phrases may be absent. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. The specification and drawings are, accordingly, to be regarded in an illustrative rather than a restrictive sense.

It will be understood that changes and modifications may be made to the disclosed embodiments without departing from the scope of the present disclosure. These and other changes or modifications are intended to be included within the scope of the present disclosure.

What is claimed is:

1. A method comprising:
receiving, via a user interface of a device, an element of an email;
generating a prompt as an input to a machine learning model based on the element of the email;
generating, using the machine learning model, formatted content based on the prompt, the formatted content corresponding to a brand associated with the email;
generating the email based on the formatted content; and
causing display of the email on the user interface of the device.

2. The method of claim 1, wherein the machine learning model comprises a large language model, and wherein the element of the email comprises one or more of a campaign type, a campaign description, an email layout, a text description of email content, a personalization element, an email template, a Uniform Resource Identifier (URI) associated with a brand asset.

3. The method of claim 2, wherein the brand asset comprises one or more of a brand image and a brand logo.

4. The method of claim 1, comprising:
causing display of a user interface on the device, the user interface including a plurality of input fields to receive a plurality of elements of the email, the plurality elements including the element of the email; and
receiving, via the user interface, the element of the email via an input field from the plurality of input fields.

5. The method of claim 1, comprising:
generating an email template based on the formatted content generated by the machine learning model; and
storing the email template along with a plurality of existing email templates for user selection.

6. The method of claim 1, comprising:
accessing historical data associated with a brand, the historical data comprising a plurality of emails associated with the brand;
generating, using the machine learning model, a plurality of elements associated with the brand based on the historical data associated with the brand; and
causing display of the plurality of elements associated with the brand on the device for user selection.

7. The method of claim 1, comprising:
receiving a user input that modifies the email generated by the machine learning model; and
storing the modified email as an email template.

8. The method of claim 1, comprising:
using the machine learning model to generate a plurality of formatted content based on the prompt;
generating a plurality of emails based on the plurality of formatted content; and
providing the plurality of emails for user selection.

9. The method of claim 1, comprising:
using the machine learning model to generate a portion of the email specified by a user of the device.

10. The method of claim 1, comprising:
receiving a request, via the device, to update a portion of the email;
using the machine learning model to generate content for the portion of the email; and
causing display of the portion of the email on the device.

11. The method of claim 1, wherein the device is an administrative device, comprising:
causing display of the email on a user interface of a recipient device.

12. A system comprising:
one or more hardware processors; and
a non-transitory machine-readable medium for storing instructions that, when executed by the one or more hardware processors, cause the one or more hardware processors to perform operations comprising:
receiving, via a user interface of a device, an element of an email;
generating a prompt as an input to a machine learning model based on the element of the email;
generating, using the machine learning model, formatted content based on the prompt, the formatted content corresponding to a brand associated with the email;
generating the email based on the formatted content; and
causing display of the email on the user interface of the device.

13. The system of claim 12, wherein the element of the email comprises one or more of a campaign type, a campaign description, an email layout, a text description of email content, a personalization element, an email template, a Uniform Resource Identifier (URI) associated with a brand asset.

14. The system of claim 13, wherein the brand asset comprises one or more of a brand image and a brand logo.

15. The system of claim 12, wherein the operations comprise:
causing display of a user interface on the device, the user interface including a plurality of input fields to receive a plurality of elements of the email, the plurality elements including the element of the email; and
receiving, via the user interface, the element of the email via an input field from the plurality of input fields.

16. The system of claim 12, wherein the operations comprise:
generating an email template based on the formatted content generated by the machine learning model; and
storing the email template along with a plurality of existing email templates for user selection.

17. The system of claim 12, wherein the operations comprise:
accessing historical data associated with a brand, the historical data comprising a plurality of emails associated with the brand;
generating, using the machine learning model, a plurality of elements associated with the brand based on the historical data associated with the brand; and
causing display of the plurality of elements associated with the brand on the device for user selection.

18. The system of claim 12, wherein the operations comprise:
receiving a user input that modifies the email generated by the machine learning model; and
storing the modified email as an email template.

19. The system of claim 12, wherein the operations comprise:
using the machine learning model to generate a plurality of formatted content based on the prompt;
generating a plurality of emails based on the plurality of formatted content; and
providing the plurality of emails for user selection.

20. A non-transitory machine-readable medium for storing instructions that, when executed by one or more hardware processors, cause the one or more hardware processors to perform operations comprising:
receiving, via a user interface of a device, an element of an email;
generating a prompt as an input to a machine learning model based on the element of the email;
generating, using the machine learning model, formatted content based on the prompt, the formatted content corresponding to a brand associated with the email;
generating the email based on the formatted content; and
causing display of the email on the user interface of the device.
